(19) United States
(12) Patent Application Publication
(10) Pub. No.: US 2023/0071820 A1
(43) Pub. Date: Mar. 9, 2023

(54) METHOD FOR EXTRACTING TARGET STRING AT HIGH-SPEED USING VECTOR INSTRUCTION

(71) Applicant: Logpresso Inc., Seoul (KR)

(72) Inventor: Bongyeol YANG, Seoul (KR)

(21) Appl. No.: 17/889,838

(22) Filed: Aug. 17, 2022

(30) Foreign Application Priority Data
Aug. 18, 2021 (KR) 10-2021-0108976

(51) Int. Cl. G06F 9/30

(52) U.S. Cl. CPC G06F 9/30036; G06F 9/3013

(57) ABSTRACT

The present disclosure provides a computer-implemented method for extracting a target string excluding delimiter from a character string, which comprises a first step of loading a unit string into a 1-0 register; a second step of loading a delimiter boundary value into a 1-1 register; a third step of loading a value calculated based on the comparison result between the 1-0 register and the 1-1 register, into a 1-2 register; a fourth step of creating a mask by transferring a feature value of the value loaded on the 1-2 register to a second register; a fifth step of creating delimiter array by calculating offset of the delimiter based on the feature value; and a sixth step of extracting the target string based on the delimiter array.

### CROSS-REFERENCE TO RELATED APPLICATION

This application claims priority to Korean Patent Application No. 10-2021-0108976 filed on Aug. 18, 2021. The application is expressly incorporated herein by reference.

### TECHNICAL FIELD

The present disclosure relates to a method that an electronic arithmetic device such as a computer extracts a target character string by use of vector instructions. In particular, the present disclosure relates to a method for extracting a target character string excluding delimiter.

### BACKGROUND

In general, a big data platform collects remote data and/or files through network. Generally, most big data is unstructured data unlike the structured data having schema which is managed by a database. In order to search the unstructured data at high speed, syntax analysis is essential for creating a full-text index or for performing standardization through value extraction for statistical processing.

The conventional big data platform has improved the performance of syntax analysis by use of multi-threading which enables multiple processor cores to be parallelly used at the same time. However, in a situation where the corporate network environment is being upgraded from 10 Gbps to 40 Gbps or more and 100 Gbps equipment are introduced to backbone system of data center, the data to be processed is extremely increasing to an extent that was unimaginable before.

For syntax analysis, it is necessary to extract a target character string (also referred to as “target string”) where delimiter having no linguistic meaning is excluded. The target character string (target string) consists of numbers and linguistic characters.

### Prior Art Reference

KR Patent No. 10-1300362 (Published on Aug. 30, 2013)

### SUMMARY

The object of the present disclosure is to provide a method for extracting a target character string through syntax analysis using vector instructions.

The present disclosure provides a computer-implemented method for extracting a target string excluding delimiter from a character string, which comprises a first step of loading a unit string into a 1-0 register; a second step of loading a delimiter boundary value into a 1-1 register; a third step of loading a value calculated based on the comparison result between the 1-0 register and the 1-1 register, into a 1-2 register; a fourth step of creating a mask by transferring a feature value of the value loaded on the 1-2 register to a second register; a fifth step of creating delimiter array by calculating offset of the delimiter based on the feature value; and a sixth step of extracting the target string based on the delimiter array.

The unit string can be provided as being plural and the first to the fifth steps can be carried out for each unit string.

The delimiter boundary value can include a first delimiter boundary value which is a next value of the greatest delimiter of a first section; a second delimiter boundary value which is an immediate lower value of the lest ascending delimiter in a second section; a third delimiter boundary value which is a next value of the most ascending delimiter in a second section; and a fourth delimiter boundary value which is an immediate lower value of the least ascending delimiter in a third section.

In ascending order of character encoding system, the first section can be the section where delimiters are arranged and a target character follows the most ascending delimiter; the second section can be the section where delimiters are arranged between two target characters; and the third section can be the section where the least ascending delimiter follows a target character but the most ascending delimiter is not blocked by a target character.

The third step can comprise a 3-1 step for loading a first comparison result between the unit string loaded on the 1-0 register and the first delimiter boundary value into a 1-2-1 register; a 3-2 step for loading a second comparison result between the unit string on the 1-0 register and the second delimiter boundary value into a 1-2-2 register, loading a third comparison result between the unit string on the 1-0 register and the third delimiter boundary value into a 1-2-3 register, carrying out a first operation to the values on the 1-2-2 register and the values on the 1-2-3 register, and loading a value indicating delimiter of the second section into a 1-2-4 register; a 3-3 step for loading a fourth comparison result between the unit string on the 1-0 register and the fourth delimiter boundary value into a 1-2-5 register; and a 3-4 step for carrying out a second operation to the values on the 1-2-1 register, the values on the 1-2-4 register and the values on the 1-2-5 register and loading a value indicating final delimiter calculated from the second operation into the 1-2 register.

The first operation can be AND bit operation and the second operation can be OR bit operation.

The first to the fourth steps can be carried out by vector instruction.

The value loaded in the 1-2 register can be “FF” for delimiter and “00” for the target character. The feature value can be MSB of the values on the 1-2 register. The second register can be a universal register.

The delimiter array can comprise the number of the identified delimiter and the offset of the identified delimiter.

The sixth step can comprise a 6-1 step for obtaining offset included in the delimiter array; a 6-2 step for assigning 0 as an initial starting position of the mask; a 6-3 step for not extracting target string and assigning <the offset+1> as the next starting position if <the offset−the starting position> equals 0; and a 6-4 step for extracting target string from the starting position to just before the offset and assigning <the offset+1> as the next starting position if <the offset−1> is not 0.

The 1-0 register, the 1-2 register, the 1-2-1 register to the 1-2-5 register can be vector register.

The present disclosure provides the system performing the method of the present disclosure.

The present disclosure provides the computer program product performing the method of the present disclosure.

### BRIEF DECRIPTION OF THE DRAWINGS

FIG. 1 is a flowchart for a method of creating memory array for target string extraction according to the present disclosure;

FIG. 2 is a flowchart for a method of extracting target string based on the memory array according to the present disclosure;

FIGS. 3 to 7 are exemplary registers for describing the identifying method of delimiter according to the present disclosure;

FIG. 8 is an exemplary mask for identifying delimiter according to the present disclosure; and

FIG. 9 is an exemplary delimiter array according to the present disclosure.

It should be understood that the above-referenced drawings are not necessarily to scale, presenting a somewhat simplified representation of various preferred features illustrative of the basic principles of the disclosure. The specific design features of the present disclosure will be determined in part by the particular intended application and use environment.

### DETAILED DESCRIPTION

Hereinafter, the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

In this specification, the order of each step should be understood in a non-limited manner unless a preceding step must be performed logically and temporally before a following step. That is, except for the exceptional cases as described above, although a process described as a following step is preceded by a process described as a preceding step, it does not affect the nature of the present disclosure, and the scope of rights should be defined regardless of the order of the steps. In addition, in this specification, “A or B” is defined not only as selectively referring to either A or B, but also as including both A and B. In addition, in this specification, the term “comprise” has a meaning of further including other components in addition to the components listed.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The term “module” or “unit” means a logical combination of a universal hardware and a software carrying out required function.

The terms “first,” “second,” or the like are herein used to distinguishably refer to same or similar elements, or the steps of the present disclosure and they may not infer an order or a plurality.

In this specification, the essential elements for the present disclosure will be described and the non-essential elements may not be described. However, the scope of the present disclosure should not be limited to the invention including only the described components. Further, it should be understood that the invention which includes additional element or does not have non-essential elements can be within the scope of the present disclosure.

The method of the present disclosure can be an electronic arithmetic device.

The electronic arithmetic device can be a device such as a computer, tablet, mobile phone, portable computing device, stationary computing device, server computer etc. Additionally, it is understood that one or more various methods, or aspects thereof, may be executed by at least one processor. The processor may be implemented on a computer, tablet, mobile device, portable computing device, etc. A memory configured to store program instructions may also be implemented in the device(s), in which case the processor is specifically programmed to execute the stored program instructions to perform one or more processes, which are described further below. Moreover, it is understood that the below information, methods, etc. may be executed by a computer, tablet, mobile device, portable computing device, etc. including the processor, in conjunction with one or more additional components, as described in detail below. Furthermore, control logic may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

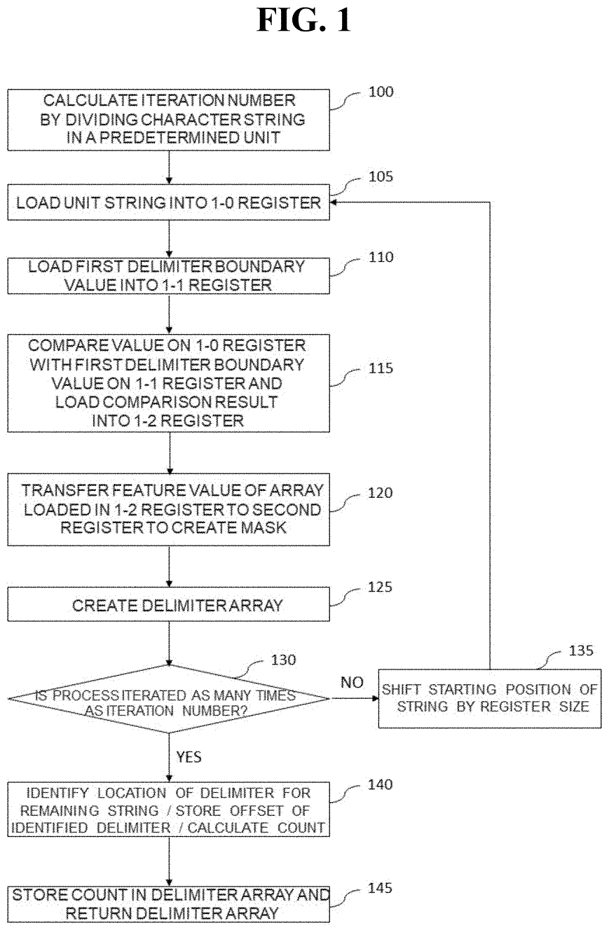

FIG. 1 is a flowchart of a method for creating delimiter array according to the present disclosure. The method illustrated in FIG. 1 is carried out prior to a method for extracting a target character string according to the present disclosure. The method of the present disclosure can be carried out by vector instructions.

In this specification, the following character string is used as an exemplary string for an easy understanding of the present disclosure. The length of the following character string is 259 bytes.

[sniper-0005] [attack_name=(30076)udr_attack_mysql_login_success_1269_120323], [time=2014/12/12 14:33:46],
[hacker=175.126.56.99], [victim=10.202.215.101], [protocol=tcp/3306], [nsk=medium], [handling=alarm], [information=],
[srcport=59939], [hacktype=02401]

In this specification, Intel's AVX2 instruction set is used for explanation of the present disclosure. Further, ASCII code is used as an exemplary character encoding system in the specification. Other encoding system such as UTF-16 and UTF-32 and the like can also be used without departing from the spirit of the present disclosure. It should be understood that the scope of the present disclosure is not limited to those embodiments.

Further, although 256-bit AVX2 register are exemplarily described in this specification, the present disclosure can also be carried out for a register having different capacity.

In the step (100), an iteration number is calculated by dividing the exemplary character string of 259 bytes in a predetermined unit. Because 256-bit AVX2 register is used as described in the above, the predetermine unit is 32 bytes. Then, the iteration number is “8,” and the remainder is “3.”

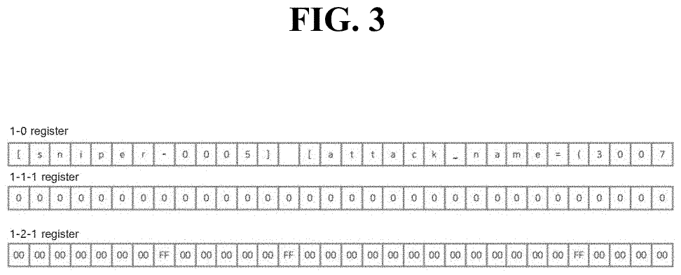

In the step (105), the character string “[sniper-0005] [attack_name=(3007” corresponding to the first 32 bytes is loaded into a 1-0 register (refer to FIG. 3) by VLDDQU instruction. Since the embodiments where AVX2 instruction set are used are described, the register can be YMM register or XMM register as vector register unless described otherwise.

In the step (110), a first delimiter boundary value is loaded into a 1-1-1 register.

The delimiter boundary values are to be loaded into a 1-1 register. Since there are a plurality of delimiter boundary values, the registers where the boundary values are loaded are denoted as 1-1-1 register, 1-1-2 register and the like by adding lower numbers to 1-1 register. The final comparison results between the 1-0 register and the 1-1 register are to be loaded into a 1-2 register. The registers where a pre-comparison result for each delimiter section is loaded are denoted as 1-2-1 register, 1-2-2 register and the like by adding lower numbers to 1-2 register.

In ascending order of character encoding system, the section where delimiters are arranged and a target character follows the most ascending delimiter is referred to as “a first section”; the section where delimiters are arranged between two target characters is referred to as “a second section”; and the section where the least ascending delimiter follows a target character and the most ascending delimiter is not blocked by a target character is referred to as “a third section.”

The first delimiter boundary value is the next value of the greatest delimiter of the first section. The second delimiter boundary value is the immediate lower value of the lest ascending delimiter in the second section. The third delimiter boundary value is the next value of the most ascending delimiter in the second section. The fourth delimiter boundary value is the immediate lower value of the least ascending delimiter in the third section.

In the ASCII code, the first delimiter boundary value is “0.” In the step (110), the value “48” in ASCII code which corresponds to the first delimiter boundary value “0” is loaded into the 1-1-1 register (refer to FIG. 3) by VMOVDQA instruction.

The values on the 1-0 register and the first delimiter boundary value on the 1-1-1 register are compared to each other by VPCMPGTB instruction and then the comparison result value is loaded into the 1-2-1 register (refer to FIG. 3).

If the value on the 1-0 register is equal to or greater than the value on the 1-1-1 register, the comparison result is assigned as “00.” Otherwise, the comparison result is assigned as “FF.”

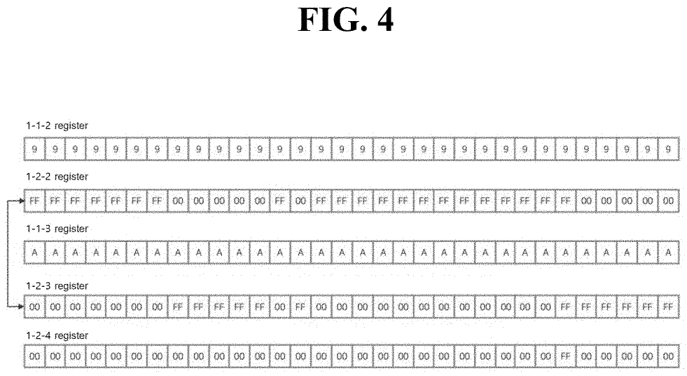

The value “57” in ASCII code which corresponds to the second delimiter boundary value “9” in the first second section is loaded into the 1-1-2 register by VMOVDQA instruction (refer to FIG. 4).

The values on the 1-0 register and the value on the 1-1-2 register are compared to each other and then the comparison result value is loaded into the 1-2-2 register (refer to FIG. 4).

If the value on the 1-0 register is greater than the value on the 1-1-2 register, the comparison result is assigned as “FF.” Otherwise, the comparison result is assigned as “00.”

The value “65” in ASCII code which corresponds to the third delimiter boundary value “A” in the first second section is loaded into the 1-1-3 register by VMOVDQA instruction (refer to FIG. 4).

The values on the 1-0 register and the value on the 1-1-3 register are compared to each other and then the comparison result value is loaded into the 1-2-3 register (refer to FIG. 4). In this case, if the value on the 1-0 register is equal to or greater than the value on the 1-1-3 register, the comparison result is assigned as “00.” Otherwise, the comparison result is assigned as “FF.”

In order to determine the location of the delimiters which belong to the second section, AND bit operation on the 1-2-2 register and the 1-2-3 register is performed by VPAND instruction and the operation result is loaded into the 1-2-4 register.

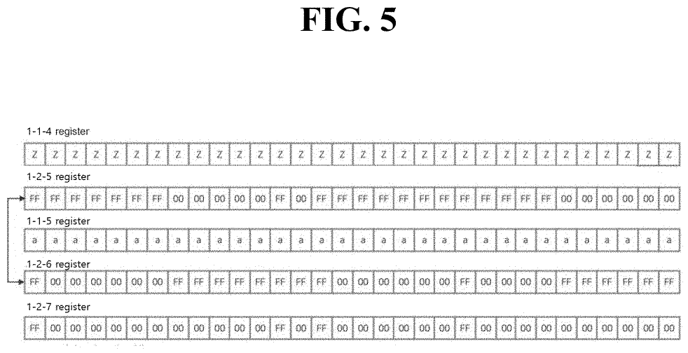

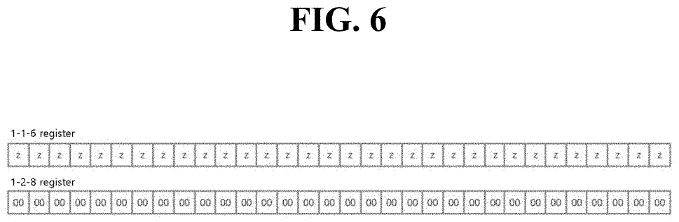

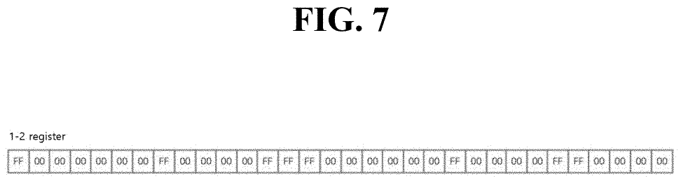

The process for identifying the delimiters which belong to the next second section will be described hereinafter. The value “90” in ASCII code which corresponds to the second delimiter boundary value “Z” in the next second section is loaded into the 1-1-4 register by VMOVDQA instruction (refer to FIG. 5).

The values on the 1-0 register and the value on the 1-1-4 register are compared to each other and then the comparison result value is loaded into the 1-2-5 register (refer to FIG. 5).

The value “97” in ASCII code which corresponds to the third delimiter boundary value “a” in the next second section is loaded into the 1-1-5 register by VMOVDQA instruction (refer to FIG. 5).

The values on the 1-0 register and the value on the 1-1-5 register are compared to each other by VPCMPGTB instruction and then the comparison result value is loaded into the 1-2-6 register (refer to FIG. 5).

In order to determine the location of the delimiters which belong to the next second section, AND bit operation on the 1-2-5 register and the 1-2-6 register is performed by VPAND instruction and the operation result is loaded into the 1-2-7 register.

The process for identifying the delimiters which belong to the third section will be described hereinafter. The value “122” in ASCII code which corresponds to the fourth delimiter boundary value “z” in the third section is loaded into the 1-1-6 register by VMOVDQA instruction.

The values on the 1-0 register and the values on the 1-1-6 register are compared to each other by VPCMPGTB instruction and then the comparison result value is loaded into the 1-2-8 register.

After the delimiters in the third section are identified, OR bit operation on the 1-2-1 register and the 1-2-4 register is performed by VPOR instruction and the operation result is loaded into the 1-2 register. Subsequently, OR bit operation on the 1-2 register and the 1-2-7 register is performed by VPOR instruction and the operation result is loaded into the 1-2 register. Finally, OR bit operation on the 1-2 register and the 1-2-8 register is performed by VPOR instruction and the operation result is loaded into the 1-2 register. Then, the step (115) is completed.

In the step (120), the feature value of the array which is loaded in the 1-2 register is transferred to a second register to create a mask. For example, the feature value of the array can be MSB (Most Significant Bit) of each value loaded on the 1-2 register. The second register can be a universal register, for example, EAX register or EDX register and the like.

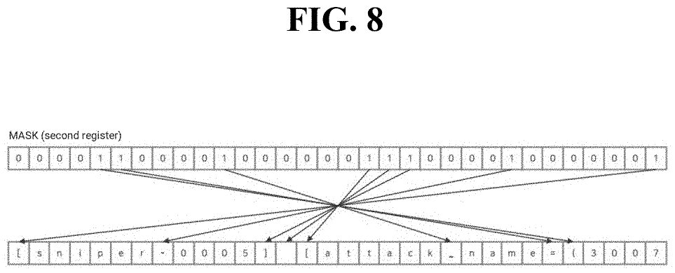

If the value loaded on the 1-2 register is “FF,” MSB (feature value) is “1.” If the value loaded on the 1-2 register is “00,” MSB (feature value) is “0.” In the embodiments illustrated in FIG. 8, the feature values are loaded on the second register by Little-endian. In the case of Java virtual machine, the feature values can be loaded on the second register by Big-endian.

In the step (125), each bit of the mask is checked to identify the location of delimiter; the offset of the identified delimiter is recorded in memory array; and then the delimiter array is created.

It is determined in the step (130) whether the steps have been iterated as many times as the iteration number. If the determination result is “NO,” the process proceeds to the step (135) to shift the starting position of the string by the register size. Then, the process returns to the step (105) to identify the location of the delimiters for the next unit string by performing the aforementioned steps.

If the determination result is “YES” in the step (130), the location of the delimiter is identified for the remining string; then the offset of the identified delimiters is recorded; and thereafter the count is calculated in the step (140).

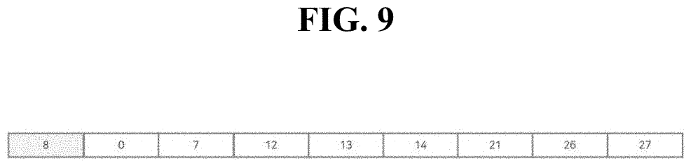

Finally, the count is stored in the delimiter array and then the delimiter array is returned in the step (145). The count can be stored in the first position of the delimiter array. FIG. 9 shows the delimiter array created by the aforementioned embodiments. The number of the identified delimiters which is “8” is stored in the first position of the delimiter array. The values in the array, which follows the count, are the offset of the identified delimiters.

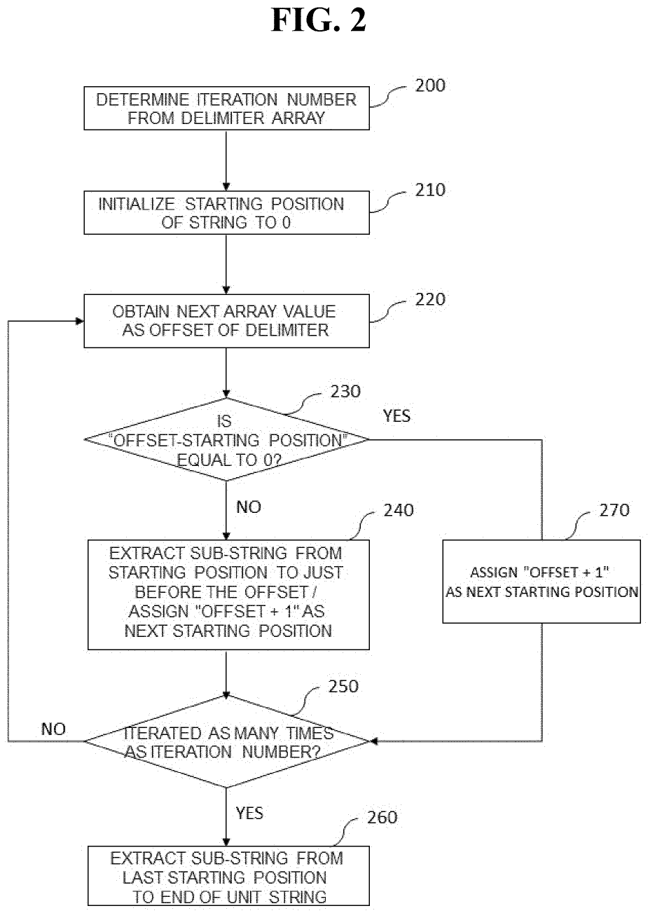

FIG. 2 is a flowchart of the method for extracting the target string by use of the delimiter array. The process illustrated in FIG. 2 relates to a method for extracting a target string for a unit character string. The process is performed for all the unit strings to extract a target string from a total character string.

In the step (200), the iteration number is determined from the delimiter array. The number of delimiters included in a unit string can be iteration number. In the example illustrated in FIG. 9, the iteration number is “8.”

In the step (210), the starting position of the string is initialized to “0.” In the step (220), the next array value, for example, “0” in the array illustrated in FIG. 9, is obtained as the offset of the first delimiter. It is determined in the step (230) whether <offset-starting position> is equal to “0” or not. If it is “0,” the process proceeds to the step (270), <offset+1> is assigned as the next starting position. If it is not “0,” the sub-string from the starting position to just before the offset is extracted, and <offset+1> is assigned as the next starting position in the step (240).

In the delimiter array in FIG. 9, the first starting position is “0” due to the initialization and the first offset is “0.” Because <offset-starting position> is equal to “0,” “1” which is the value of <offset+1>, is assigned as the next starting position in the step (270). It is determined in the step (250) whether the process has been iterated as many times as the iteration number. In the step (220), the next array value “7” is obtained as the offset of the delimiter.

<7 (offset)−1 (starting position)> equals 6. Thus, in the step (240), the sub-string “sniper” which is from the starting position “1” and to the just before the offset “7” is extracted and then “8” which is calculated by adding “1” to “7 (offset)” is assigned as the next starting position.

<12 (next offset)−8 (starting position)> equals “4” which is greater than “0.” Thus, in the step (240), the sub-string “0005” from the starting position “8” to the just before the offset “12,” is extracted and then “13” (equals “12 (offset)+1”) is assigned as the next offset.

After the process is iterated as many times as the iteration number, the sub-string which is from the last starting position to the end of the unit string is extracted.

According to the present disclosure, a target string can be extracted in high-speed by syntax analysis.

Although the comparison unit of the aforementioned embodiments is one bye, the comparison unit can be WORD or QWORD in the embodiments using UTF-16 or UTF-32 encoding system.

In the prior arts, a delimiter is identified by character-by-character analysis. For example, a scalar operator is used for identifying if each character belongs to delimiters. Alternatively, a specific location in memory is queried based on a code point (i.e., ASCII Code) for identifying if the character is a delimiter.

The present disclosure provides a method for performing syntax analysis by use of vector operator which is supported by a processor or virtual machine. Intel Corporation has continuously released vector instruction set such as SSE, AVX, AVX2, and AVX-512 since it released MMX. The latest AVX-512 instructions process 512 bits in one operation. That is, the operation using the vector instruction set can achieve 64 times faster than the conventional arts in terms of register operation because it can simultaneously process 64 characters for ASCII Codes consisting of 8-bit characters with the same number of instructions.

On the other hand, JAVA 16 released in March 2021 supports performance acceleration by executing JIT compilation (Just-in-time compilation) with the vector operator of a processor even in Java virtual machine through the vector API. In this execution environment, the present disclosure can improve the performance of the syntax analysis several times.

Although the present disclosure has been described with reference to accompanying drawings, the scope of the present disclosure is determined by the claims described below and should not be interpreted as being restricted by the embodiments and/or drawings described above. It should be clearly understood that improvements, changes and modifications of the present disclosure disclosed in the claims and apparent to those skilled in the art also fall within the scope of the present disclosure. Accordingly, this description is to be taken only by way of example and not to otherwise limit the scope of the embodiments herein.

What is claimed is:

1. A computer-implemented method for extracting a target string excluding delimiter from a character string, the method comprising:
a first step of loading a unit string into a 1-0 register;
a second step of loading a delimiter boundary value into a 1-1 register;
a third step of loading a value calculated based on the comparison result between the 1-0 register and the 1-1 register, into a 1-2 register;
a fourth step of creating a mask by transferring a feature value of the value loaded on the 1-2 register to a second register;
a fifth step of creating delimiter array by calculating offset of the delimiter based on the feature value; and
a sixth step of extracting the target string based on the delimiter array.

2. The method according to claim 1, wherein the unit string is plural and the first to the fifth steps are carried out for each unit string.

3. The method according to claim 1, wherein the delimiter boundary value includes a first delimiter boundary value which is a next value of the greatest delimiter of a first section; a second delimiter boundary value which is an immediate lower value of the lest ascending delimiter in a second section; a third delimiter boundary value which is a next value of the most ascending delimiter in a second section; and a fourth delimiter boundary value which is an immediate lower value of the least ascending delimiter in a third section,
wherein in ascending order of character encoding system, the first section is the section where delimiters are arranged and a target character follows the most ascending delimiter; the second section is the section where delimiters are arranged between two target characters; and the third section is the section where the least ascending delimiter follows a target character but the most ascending delimiter is not blocked by a target character, and
wherein the third step comprises a 3-1 step for loading a first comparison result between the unit string loaded on the 1-0 register and the first delimiter boundary value into a 1-2-1 register; a 3-2 step for loading a second comparison result between the unit string on the 1-0 register and the second delimiter boundary value into a 1-2-2 register, loading a third comparison result between the unit string on the 1-0 register and the third delimiter boundary value into a 1-2-3 register, carrying out a first operation to the values on the 1-2-2 register and the values on the 1-2-3 register, and loading a value indicating delimiter of the second section into a 1-2-4 register; a 3-3 step for loading a fourth comparison result between the unit string on the 1-0 register and the fourth delimiter boundary value into a 1-2-5 register; and a 3-4 step for carrying out a second operation to the values on the 1-2-1 register, the values on the 1-2-4 register and the values on the 1-2-5 register and loading a value indicating final delimiter calculated from the second operation into the 1-2 register.

4. The method according to claim 3, wherein the first operation is AND bit operation and the second operation is OR bit operation.

5. The method according to claim 1, wherein the first to the fourth steps are carried out by vector instruction.

6. The method according to claim 1, wherein the value loaded in the 1-2 register are “FF” for delimiter and “00” for the target character; wherein the feature value is MSB of the values on the 1-2 register; and wherein the second register is a universal register.

7. The method according to claim 1, wherein the delimiter array comprises the number of the identified delimiter and the offset of the identified delimiter.

8. The method according to claim 7, wherein the sixth step comprises a 6-1 step for obtaining offset included in the delimiter array; a 6-2 step for assigning 0 as an initial starting position of the mask; a 6-3 step for not extracting target string and assigning <the offset+1> as the next starting position if <the offset — the starting position>equals 0; and a 6-4 step for extracting target string from the starting position to just before the offset and assigning <the offset+1> as the next starting position if <the offset−1> is not 0.

9. The method according to claim 5, wherein the 1-0 register, the 1-2 register, the 1-2-1 register to the 1-2-5 register are vector register.

10. A computer-implemented system comprising one or more processors and one or more computer-readable media storing computer-executable instructions that, when executed, cause the one or more processors to perform a method comprising:
a first step of loading a unit string into a 1-0 register;
a second step of loading a delimiter boundary value into a 1-1 register;
a third step of loading a value calculated based on the comparison result between the 1-0 register and the 1-1 register, into a 1-2 register;
a fourth step of creating a mask by transferring a feature value of the value loaded on the 1-2 register to a second register;
a fifth step of creating delimiter array by calculating offset of the delimiter based on the feature value; and
a sixth step of extracting the target string based on the delimiter array.

11. A computer program product comprising one or more computer-readable storage media and program instructions stored in at least one of the one or more storage media, the program instructions executable by a processor to cause the processor to perform a method comprising:
a first step of loading a unit string into a 1-0 register;
a second step of loading a delimiter boundary value into a 1-1 register;
a third step of loading a value calculated based on the comparison result between the 1-0 register and the 1-1 register, into a 1-2 register;
a fourth step of creating a mask by transferring a feature value of the value loaded on the 1-2 register to a second register;
a fifth step of creating delimiter array by calculating offset of the delimiter based on the feature value; and
a sixth step of extracting the target string based on the delimiter array.
